(19) United States
(12) Patent Application Publication
(10) Pub. No.: US 2012/0228457 A1
(43) Pub. Date: Sep. 13, 2012

(54) BALLOON HOLDER WITH LOCKING FINGERS

(75) Inventors: John J. Gilbert, Maple Grove, MN (US); Scott W. Gardner, Wayzata, MN (US)

(73) Assignee: Anagram International, Inc., Eden Prairie, MN (US)

(21) Appl. No.: 13/046,180

(22) Filed: Mar. 11, 2011

(51) Int. Cl. F16M 13/00

(52) U.S. Cl. 248/309.1

(57) ABSTRACT

A balloon holder includes a stem for locking a balloon tail in place. The stem includes an inner channel for receiving the balloon tail. The inner channel is located between side walls of the stem, and pairs of locking fingers extend from the side walls into the inner channel. The application of a deforming force to the locking fingers causes the locking fingers to bend, thereby allowing the balloon tail to enter the inner channel. When the deforming force is removed the locking fingers return to a substantially planar state, thereby locking the balloon tail in place within the inner channel.

### TECHNICAL FIELD

The present invention relates to a balloon holder, and more particularly, to a balloon holder including locking fingers to lock the tail of the balloon into the holder and keep the balloon in place.

### BACKGROUND OF THE INVENTION

The use of balloons for various functions and purposes has become extremely popular. Often, the balloon is secured to the end of a stick. In order to keep the balloon in a desired and secured location with respect to the stick, the balloon is typically received in a cup. Usually the valve tail of the balloon is manually threaded through an opening in the cup sidewall and then is wound into a knot to maintain the balloon securely in the seated arrangement in the cup and seal the valve in the balloon tail. Thereafter, the cup is secured to a stick or straw slid into the bottom of the stem depending from the cup.

FIGS. 1 and 2 show a prior art balloon 10 having a balloon tail 12 with an end 14 distal to the balloon 10. The balloon holder 16 has an upper ring 18 supported by outwardly flaring vertical supports 20. The holder 16 has a depending stem 22 for securing the balloon holder 16 onto a mounting stick or straw 24. It can be appreciated that the balloon tail 12 is wound about the vertical supports 20, forming a knot to secure the balloon 10 to the balloon holder 16 and to prevent leakage of air from the balloon tail 12.

FIG. 3 is another prior art balloon holder 30, which mounts and holds a balloon 10 having a balloon tail 12 with an end 14 distal to the balloon 10. Balloon holder 30 includes a cup 32 with a depending slot 34 through the length of the cup and a depending stem 36 for receiving a mounting stick 24. Attached to the outside of the cup 32 is a tail-catch notch or angled slot 38 which receives the balloon tail 12 of the balloon 10 to lock the balloon in the balloon holder 30 securely and to prevent leakage of gas or air from the balloon tail 12.

### SUMMARY OF THE INVENTION

The present invention is directed to a balloon holder for locking a balloon tail in place. The balloon holder has a stem including an inner channel between a first side wall and a second side wall. A first locking finger extends into the inner channel from the first side wall, and a second locking finger extends into the inner channel from the second side wall. The first locking finger and the second locking finger are together capable of holding the balloon tail, after bending to allow the balloon tail to enter the inner channel.

The present invention is also directed to a balloon holder for locking a balloon tail in place, the balloon holder having a stem including an inner channel between a first side wall and a second side wall, and a plurality of pairs of locking fingers. A first locking finger of each pair of locking fingers extends into the inner channel from the first side wall, and a second locking finger of each pair of locking fingers extends into the inner channel from the second side wall. The plurality of pairs of locking fingers are capable of holding the balloon tail, after bending to allow the balloon tail to enter the inner channel.

In some embodiments, the balloon holder of the present invention may include a frustoconical top for supporting and holding a balloon, and/or an opening in the base of the stem of the balloon holder for receiving a mounting stick.

A principal object and advantage of the present invention is that it permits a balloon, balloon holder, and balloon mounting stick to be efficiently and securely assembled by locking the balloon tail into the stem of the balloon holder, and inserting the mounting stick into the base of the stem of the balloon holder. The assembly process can be automated.

Another object and advantage of the present invention is that it provides a balloon retailer a quick and easy way of mounting a balloon on a balloon holder, with the simple insertion of the balloon tail and mounting stick into the stem of the balloon holder.

Another object and advantage of the present invention is that it allows balloons to be securely mounted in various receptacles such as bowls and planters, by incorporating the balloon holder of the present invention into said receptacles.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIGS. 1 and 2 are front elevational views of a character balloon mounted in a balloon holder of the prior art.

FIG. 3 is a front perspective view of another balloon holder of the prior art.

FIG. 4 is a front perspective view of one embodiment of the balloon holder of the present invention, including a mounting stick and a balloon supported by the balloon holder.

FIG. 5 is a front perspective view of the balloon holder of FIG. 4.

FIG. 6 is a side elevational view of the balloon holder of FIG. 4.

FIG. 7 is a front elevational view of the balloon holder of FIG. 4.

FIG. 8 is a top plan view of the balloon holder of FIG. 4.

FIG. 9 is a bottom plan view of the balloon holder of FIG. 4.

FIG. 10 is a cross-sectional view of a balloon holder taken along lines 10 of FIG. 4, including a mounting stick, showing a balloon tail being inserted into the balloon holder using a rod.

FIG. 11 is a cross-sectional view of a balloon holder taken along lines 10 of FIG. 4, including a mounting stick, showing a balloon tail that has been inserted into the balloon holder using a rod.

FIG. 12 is a front perspective view of a balloon incorporating the balloon holder of FIG. 4.

FIG. 13 is a cross-sectional view of a container incorporating the balloon holder of FIG. 4.

FIG. 14 is a cutaway view of a container incorporating a second embodiment of the balloon holder of the present invention.

FIG. 15 is a cutaway view of a receptacle incorporating the balloon holder of FIG. 14.

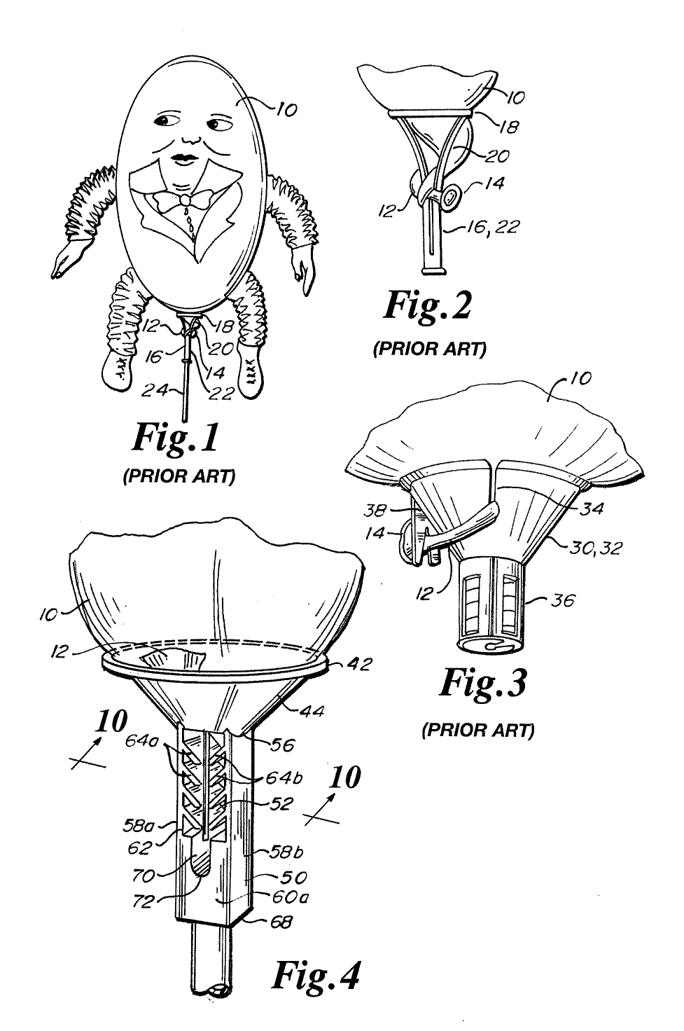

### DETAILED SPECIFICATION

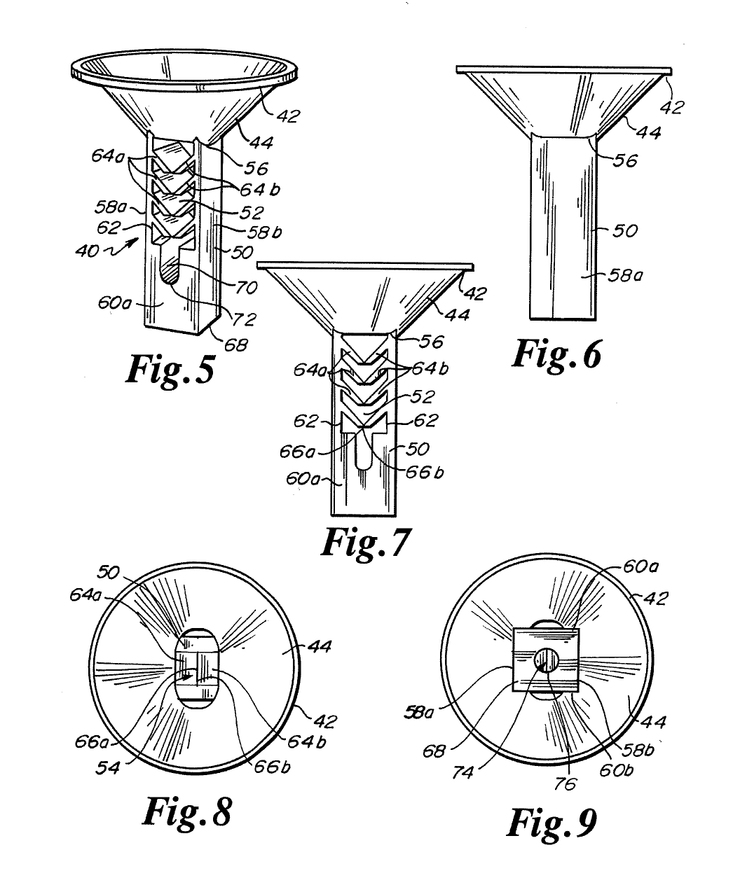

Referring to FIGS. 4 through 15, the improved balloon holder of the present invention may be appreciated.

FIGS. 4-11 illustrate a balloon holder 40 in accordance with one embodiment of the present invention. The balloon holder 40 includes a frustoconical top 42 having a side wall 44. The frustoconical top 42 may support a balloon 10 secured in the balloon holder 40. In some embodiments, the top 42 may have a shape other than a frustoconical shape, such as a flat shape or pyramidal shape. The top 42 is supported by a stem 50. Stem 50 includes an inner channel 52 which may receive a balloon tail 12. The opening 54 to the inner channel 52 is at the top end 56 of the stem 50.

The inner channel 52 includes a first side wall 58a and a second side wall 58b, which are on opposite sides of the stem 50 from each other. The inner channel 52 also includes a third side wall 60a and a fourth side wall 60b, which are also on opposite sides of the stem 50 from each other. Extending from the inner surfaces 62 of first and second side walls 58a, 58b are locking fingers 64a, 64b which extend inwardly at a downward slant. The locking fingers 64a, 64b are arranged in pairs, with the first locking finger 64a of each pair extending from the first side wall 58a and the second locking finger 64b of each pair extending from the opposite, second side wall 58b. As shown in FIGS. 7-10, the outer end 66a of the first locking finger 64a meets the outer end 66b of the second locking finger 64b. However, in other embodiments, the outer end 66a of first locking finger 64a may be spaced apart from the outer end 66b of second locking finger 64b, so long as outer ends 66a and 66b are close enough to enable locking fingers 64a and 64b to hold a balloon tail 12. The locking fingers 64a, 64b have a substantially planar state, with each locking finger comprising a declining plane extending at a downward slant from the first side wall 58a or second side wall 58b toward the base 68, in the absence of a deforming force applied to the locking fingers. The locking fingers 64a, 64b also have a tendency to return to their original substantially planar state when the deforming force is removed.

The locking fingers 64a, 64b are one-way locking fingers, such that a deforming force applied on the locking fingers in the downward direction, toward the base 68, causes the locking fingers 64a, 64b to bend downwardly, thereby providing space between outer ends 66a, 66b of locking fingers 64a, 64b, which allows a balloon tail 12 to pass into the inner channel 52 from the opening 54 toward the base 68. However, if a balloon tail 12 located in the inner channel 52 is pulled in the upward direction toward the top end 56 of the stem 50, the force of the locking fingers 64a, 64b acting against the balloon tail 12 locks the balloon tail 12 in place, preventing the balloon tail 12 from being pulled through the stem 50 in the upward direction.

In the embodiments shown in FIGS. 4-15, the inner channel 52 includes four pairs of locking fingers 64a, 64b. However, other embodiments may include a lesser or greater number of pairs of locking fingers. Also, the embodiments shown in FIGS. 4-15 include two side walls 58a, 58b which support locking fingers 64a, 64b, and two side walls 60a, 60b which do not support locking fingers. However, in other embodiments, the stem 50 may include a greater or lesser number of side walls which support locking fingers, and/or a greater or lesser number of side walls which do not support locking fingers.

The locking fingers may be made from a material which bends when force is applied to it but which is sufficiently resilient to return to its original shape when the force is removed. For example, various polymer materials may be used.

Below the locking fingers 64a, 64b, the inner channel 52 may include a recess 70 which has a smaller cross-sectional diameter than the portion of the inner channel 52 including locking fingers 64a, 64b. The inner channel 52 extends to the lower end 72 of the recess 70.

As shown in FIGS. 9-11, the stem 50 has a mounting stick inner channel 74 which is circular in cross section so as to receive in fitted fashion a cylindrical mounting stick or straw 24. The opening 76 to the mounting stick inner channel 74 is located in the base 68 of the stem 50. In other embodiments, the mounting stick inner channel 74 may be another shape in cross section, such as a square or triangle, in order to receive mounting sticks of various shapes.

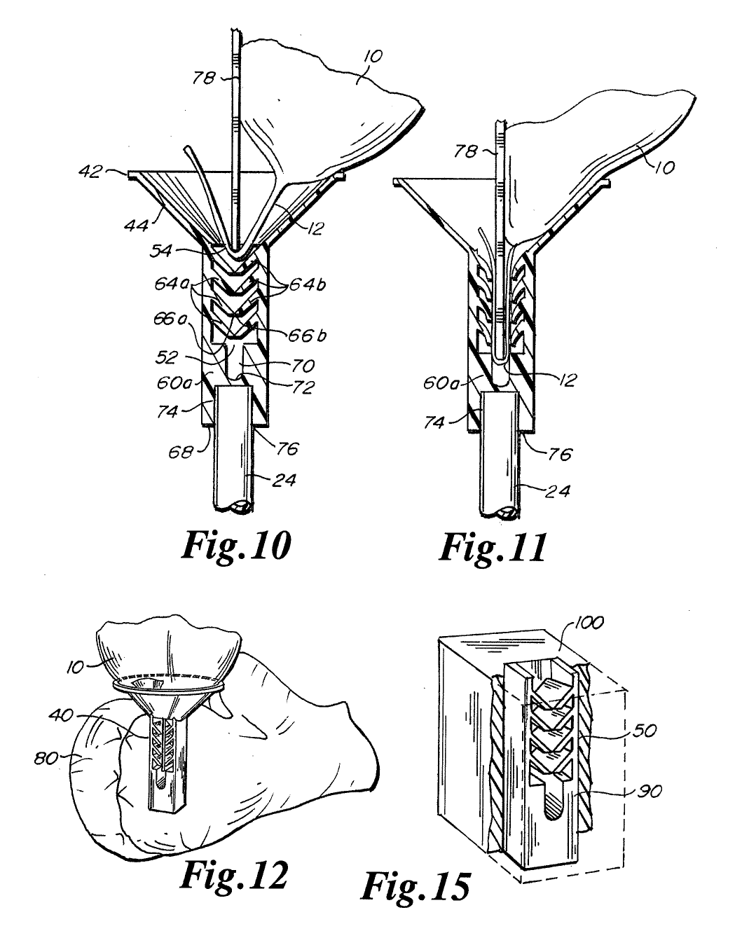

In operation, the balloon holder 40 receives the balloon tail 12 of the balloon 10 through the opening 54 to the inner channel 52. The balloon tail 12 is pushed into the inner channel 52 between the outer ends 66a, 66b of locking fingers 64a, 64b. The application of a deforming force on the locking fingers 64a, 64b in a downward direction causes the locking fingers to bend downwardly toward the base 68 of the stem 50, thereby creating a space between the outer ends 66a, 66b of locking fingers 64a, 64b which allows the balloon tail 12 to pass into the inner channel 52. As shown in FIGS. 10-11, a rod 78 may be used to insert balloon tail 12 into the balloon holder 40. As shown in FIG. 10, the balloon tail 12 may be placed into the top 42, such that the balloon tail 12 extends over the opening 54 to the inner channel 52. The end of the rod 78 may then be placed on the portion of the balloon tail 12 extending over the opening 54. As shown in FIG. 11, the rod 78 is then used to push the balloon tail 12 into the inner channel 52. The pressure of the rod 78 against the locking fingers 64a, 64b causes the locking fingers to bend in a downward direction to allow the rod 78 and balloon tail 12 to enter the inner channel 52. The rod 78 may be pushed into the inner channel 52 until the portion of the balloon tail 12 beneath the end of the rod contacts the lower end 72 of the recess 70. In the embodiment shown in FIGS. 10 and 11, the rod 78 is of a sufficiently small diameter to fit within the recess 70. As the balloon tail 12 is pushed downwardly within the inner channel 52, the balloon 10 is drawn into the frustoconical top 42 to securely mount and support the balloon within the balloon holder 40.

After the balloon tail 12 has been inserted into the inner channel 52 as shown in FIGS. 10-11, the rod 78 is removed by pulling the rod out of the inner channel 52 in an upward direction toward the top 42. When the rod 78 is removed, the locking fingers 64a, 64b return to their original substantially planar state to the extent allowed by the presence of the balloon tail 12, such that the balloon tail 12 is held in place between the inner ends 66a, 66b of the locking fingers 64a, 64b. Depending on the length of the valve tail 12, the end 14 of the valve tail may be held within the inner channel 52, or the end 14 may extend through the opening 54 into the top 42.

The balloon tail 12 may be inserted into the inner channel 52 after tying a knot in the balloon tail. Alternatively, the balloon tail 12 may be inserted into the inner channel 52 without tying a knot in the balloon tail, and the pressure of locking fingers 64a, 64b on the balloon tail 12 can be used to prevent the leakage of air or other gases from the balloon 10.

In some embodiments, the side wall 44 of the frustoconical top 42 may include one or more slits extending from the rim of the top 42 to the stem 50. When such embodiments are used, a balloon tail 12 may be passed through the slit or slits in the process of inserting the balloon tail 12 in the balloon holder 40. Also, some embodiments may include a vertical slit in one or both of the third and fourth side walls 60a, 60b, extending from the lower end 72 of the recess 70 to the base 68 of the stem 50. If a slit in the side wall 44 of the frustoconical top 42 aligns with the center of inner channel 52, and with the slit in the third or fourth side wall 60a, 60b, then the balloon tail 12 may be inserted in the inner channel 52 by pulling the balloon tail 12 through the side of balloon holder 40, through the slit in the side wall 44 of frustoconical top 42, and through both the open portion and the slit in side wall 60a or 60b.

In the embodiments shown in FIGS. 4-15, the third and fourth side walls 60a, 60b are partially open, thereby allowing a user to view the balloon tail 12 when it is inserted into the inner channel 52. Partially open side walls also provide a user access to the inner channel 52, if the user chooses to assist in pushing the balloon tail 12 into the inner channel 52 by extending an implement, such as tweezers or a rod, through the side walls 60a, 60b to contact the balloon tail 12. After a balloon tail 12 has been inserted into the inner channel 52, access to the inner channel through partially open side walls may also allow a user to bend the locking fingers 64a, 64b downward in order to release the balloon tail 12 from the inner channel 52. However, in other embodiments, the stem 50 may include four unbroken sidewalls, such that the balloon tail 12 is not visible within the stem 50. Alternatively, the stem 50 may include side walls which are unbroken but transparent, thereby allowing the valve tail 12 to be seen within the stem 50 without the use of partially open side walls.

A mounting stick 24 may be inserted into the mounting stick inner channel 74, either before, after, or during the insertion of the balloon tail 12 into the inner channel 52.

These assembly steps may be simply automated by machinery. Alternately, a retailer may assemble the balloon 10 with the balloon holder 40 in a quick and simple fashion. It is estimated that balloons 10 could be assembled with balloon holders 40, when using an automated process to insert the valve tails 12 into the inner channels 52, at a rate of approximately 600-800 balloons per hour.

The balloon holder 40 can be used in conjunction with other balloons besides the balloon 10 that is supported in the balloon holder. For example, FIG. 12 shows a balloon 80 in the shape of a mitten. Balloon 80 is attached to balloon holder 40 by, for example, adhesive means, such that it appears that the balloon holder is being held by balloon 80.

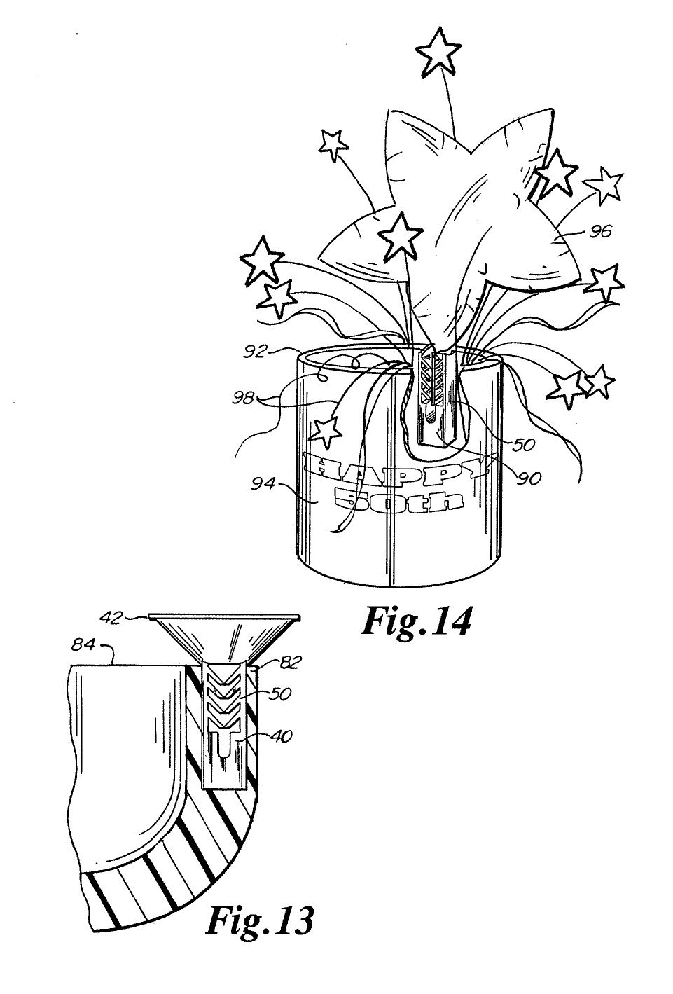

The balloon holder 40 can also be used in conjunction with various receptacles for holding articles such as flowers, decorations, and gifts. For example, FIG. 13 shows a balloon holder 40 wherein the stem 50 is inserted into the edge 82 of a bowl 84.

FIGS. 14 and 15 show a second embodiment of a balloon holder of the present invention. In this embodiment, the balloon holder 90 includes a stem 50, but does not include a frustoconical top 42. This embodiment of a balloon holder may also be used in conjunction with various balloons and receptacles. For example, FIG. 14 shows a balloon holder 90 that has been inserted into the edge 92 of a decorative container 94. The balloon holder 90 holds balloon 96, while the container 94 holds various decorations 98.

FIG. 15 shows a balloon holder 90 incorporated into a receptacle 100. The receptacle 100 may be a free-standing receptacle which can support the balloon holder 90 when placed on a table or other surface.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A balloon holder for locking a balloon tail in place, comprising:
a stem including an inner channel between a first side wall and a second side wall, wherein a first locking finger extends into the inner channel from the first side wall, and a second locking finger extends into the inner channel from the second side wall, and wherein the first locking finger and the second locking finger are together capable of holding the balloon tail after bending to allow the balloon tail to enter the inner channel.

2. The balloon holder of claim 1, further comprising a top supported by the stem.

3. The balloon holder of claim 2, wherein the top has a frustoconical shape.

4. The balloon holder of claim 1, further comprising an opening in a base of the stem for receiving a mounting stick.

5. The balloon holder of claim 1, wherein the first side wall is opposite to the second side wall.

6. The balloon holder of claim 1, said stem further comprising a third side wall, wherein the third side wall is partially open to allow the balloon tail to be seen within the stem.

7. The balloon holder of claim 1, wherein the first side wall and the second side wall each support a plurality of locking fingers.

8. The balloon holder of claim 1, wherein the first locking finger and the second locking finger each have an original substantially planar state, comprising a declining plane extending toward a base of the stem, and a tendency to return to said substantially planar state after application of a deforming force.

9. A balloon holder for locking a balloon tail in place, comprising:
a stem including an inner channel between a first side wall and a second side wall, and a plurality of pairs of locking fingers, wherein a first locking finger of each pair of locking fingers extends into the inner channel from the first side wall, and a second locking finger of each pair of locking fingers extends into the inner channel from the second side wall, and wherein the plurality of pairs of locking fingers are capable of holding the balloon tail after bending to allow the balloon tail to enter the inner channel.

10. The balloon holder of claim 9, further comprising a top supported by the stem.

11. The balloon holder of claim 10, wherein the top has a frustoconical shape.

12. The balloon holder of claim 9, further comprising an opening in a base of the stem for receiving a mounting stick.

13. The balloon holder of claim 9, wherein the first side wall is opposite to the second side wall.

14. The balloon holder of claim 9, said stem further comprising a third side wall, wherein the third side wall is partially open to allow the balloon tail to be seen within the stem.

15. The balloon holder of claim 9, wherein each locking finger of the plurality of pairs of locking fingers has an original substantially planar state, comprising a declining plane extending toward a base of the stem, and a tendency to return to said substantially planar state after application of a deforming force.

16. A balloon holder for supporting and holding a balloon and for locking a balloon tail of the balloon in place, comprising:
a) a frustoconical top; and
b) a stem depending from the frustoconical top, said stem including an inner channel between a first side wall and a second side wall, and a plurality of pairs of locking fingers, wherein a first locking finger of each pair of locking fingers extends into the inner channel from the first side wall, and a second locking finger of each pair of locking fingers extends into the inner channel from the second side wall, and wherein the plurality of pairs of locking fingers are capable of holding the balloon tail after bending to allow the balloon tail to enter the inner channel.

17. The balloon holder of claim 16, further comprising an opening in a base of the stem for receiving a mounting stick.

18. The balloon holder of claim 1, wherein the first side wall is opposite to the second side wall.

19. The balloon holder of claim 1, said stem further comprising a third side wall, wherein the third side wall is partially open to allow the balloon tail to be seen within the stem.

20. The balloon holder of claim 1, wherein each locking finger of the plurality of pairs of locking fingers has an original substantially planar state, comprising a declining plane extending toward a base of the stem, and a tendency to return to said substantially planar state after application of a deforming force.
